(19) United States
(12) Patent Application Publication
(10) Pub. No.: US 2008/0210342 A1
(43) Pub. Date: Sep. 4, 2008

(54) Anodic oxidation coating remover composition and method of removing anodic oxidation coatings

(75) Inventors: Katsuyuki Iijima, Kobe-shi (JP); Tetsuo Suzuki, Kobe-shi (JP)

Correspondence Address: REED SMITH LLP, 3110 FAIRVIEW PARK DRIVE, SUITE 1400, FALLS CHURCH, VA, 22042, US

(73) Assignee: Kabushiki Kaisha Kobe Seiko Sho

(21) Appl. No.: 12/007,324

(22) Filed: Jan. 9, 2008

(30) Foreign Application Priority Data
Jan. 12, 2007 (JP) 2007-005052

(51) Int. Cl. C23C 22/82; C09K 3/00

(52) U.S. Cl. 148/272; 252/182.33

(57) ABSTRACT

Anodic oxidation coatings are selectively removed from anodic oxidation-treated aluminum or aluminum alloy members by immersion in a solution composition.

By using a remover composition characterized by containing phosphoric acid and a molybdate salt, it is possible to selectively remove the anodic oxidation coatings from the aluminum or aluminum alloy members without substantially dissolving the basis metal aluminum or aluminum alloy.

### FIELD OF THE INVENTION

The present invention relates to a remover composition capable of selectively removing anodic oxidation coatings obtained by anodic oxidation of aluminum or aluminum alloy members and to a method of removing anodic oxidation coatings using the remover composition.

### BACKGROUND OF THE INVENTION

In certain instances, aluminum or aluminum alloy members have anodic oxidation coatings resulting from anodic oxidation treatment for the purpose of surface hardening or providing the surface with corrosion resistance. In cases where it is necessary to partially remover or re-treat the anodic oxidation coatings formed by anodic oxidation treatment, the anodic oxidation coatings are removed by the chemical etching or shot blast technique, for instance.

The chemical etching technique uses such a remover composition (etching solution) as (1) a phosphoric acid-chromic acid mixed solution, (2) an aqueous sodium hydroxide solution, (3) a sulfuric acid-hydrofluoric acid mixed solution, (4) a sulfuric acid-potassium fluoride mixed solution, or (5) a nitric acid-hydrofluoric acid mixed solution (Non-Patent Document 1: Japan Light Metal Association (ed.): Aruminium Hyakkajiten (Encyclopedia of Aluminum)). Further, Patent Document 1 (Japanese Patent Laid-open No. 2004-211128) discloses a method of removing oxide coatings in regenerating aluminum members for semiconductor manufacturing apparatus which comprises carrying out etching with a phosphoric acid/chromic acid solution, a sodium hydroxide solution or a potassium hydroxide solution. Patent Document 2 (Japanese Patent Laid-open No. S58-22389 discloses a method of removing anodic oxidation coatings which comprises carrying out reverse electrolysis with aluminum as a cathode to generate hydrogen gas at the interface between the anodic oxidation coating and basis metal aluminum, and a method of removing anodic oxide coatings which comprises supplying an electric current to aluminum in an organosilane compound solution. Patent Document 3 (Japanese Patent Laid-open No. S61-90777) discloses a method of removing anodized aluminum (Alumite) by shot blasting, not by any chemical method, in view of the fact that the sulfuric acid-based chemicals in conventional use corrode the basis metal and are hazardous.

Phosphoric acid-chromic acid mixed solutions will not damage basis material aluminum or aluminum alloy members but contain chromium hazardous to the environment, which necessitates a large-scale waste liquid and wastewater treatment. In particular, in recent years, chromium has become one of the targets of the so-called RoHS (Restriction of Hazardous Substances) directive, and the restriction of the use of chromium is becoming severer and severer. Aqueous sodium hydroxide solutions can efficiently dissolve and remove anodic oxidation coatings but they can also dissolve the basis material aluminum or aluminum alloy, causing significant changes in size of members in the coating elimination process. Sulfuric acid-hydrofluoric acid mixed solutions, sulfuric acid-potassium fluoride mixed solutions and nitric acid-hydrofluoric acid mixed solutions all can efficiently remove anodic oxidation coatings at ordinary temperature but, like aqueous solutions of sodium hydroxide, they can dissolve the basis material aluminum or aluminum alloy, causing significant changes in size of members in the course of removing coatings. Once significant changes in member size have occurred, aluminum or aluminum alloy members to be used as members required to meet high-level dimensional precision requirements, such as members to be used in semiconductor device manufacturing apparatus, may unfavorably no longer satisfy the standard requirements as such members when again subjected to anodic oxidation treatment for regeneration after removal of the former anodic oxidation coatings.

The method of removing anodic oxidation coatings by feeding an electric current to aluminum in an organosilane compound solution requires much time and work and the coating removing work becomes troublesome and, furthermore, the method sometimes fails to remove part of the anodic oxidation coatings; the method is thus unfavorable. The mechanical removing method such as shot blasting is applicable to materials simple in shape, such as plates or rods, but cannot be applied to members complicated in shape.

### SUMMARY OF THE INVENTION

The present invention, which has been made in view of the above-discussed circumstances, has its object to provide a removing composition and a removing method for selectively removing anodic oxidation coatings from anodic oxidation-treated aluminum or aluminum alloy members by immersing them in a solution or composition.

The present invention, which could have accomplished the above object, consists in a composition for removing anodic oxidation coatings which is characterized in that it comprises phosphoric acid and a molybdate salt. By causing phosphoric acid capable of dissolving anodic oxidation coatings and a molybdate salt capable of forming a novel coating on the surface of the basis material aluminum or aluminum alloy to be simultaneously contained in the remover composition, it becomes possible to selectively remove anodic oxidation coatings without substantially dissolving the basis material aluminum or aluminum alloy. By saying “without substantially dissolving the basis material aluminum”, it is meant that the reduction in the thickness of the basis material aluminum or aluminum alloy after treatment is not larger than 10 μm as compared with that before treatment.

Suitably, the remover composition has a phosphoric acid concentration of 10 g/l to 400 g/l and a molybdate ion concentration of 0.5 g/l to 150 g/l. Further, it is also possible to improve the homogeneity of the aluminum or aluminum alloy surface after treatment by adding an oxidizing agent, preferably the nitrate ion, in an amount of 0.5 g/l to 200 g/l.

The method of removing anodic oxidation coatings according to the invention is characterized in that an aluminum or aluminum alloy member treated by anodic oxidation is immersed in a remover composition simultaneously containing a component capable of dissolving the anodic oxidation coating and a component capable of newly forming a molybdenum-containing coating or layer on the aluminum or aluminum alloy surface and then the member is immersed in a solution capable of dissolving the molybdenum-containing coating to remove the newly formed molybdenum-containing coating. More specifically, the anodic oxidation-treated aluminum or aluminum alloy member is immersed in the above remover solution for the removal of the anodic oxidation coating and the simultaneous formation of a molybdenum-containing coating in lieu of the same and then the member is immersed in an aqueous nitric acid solution having a nitrate ion concentration of 50 g/l to 360 g/l for the removal of the molybdenum-containing coating. While some other method may be used for removing the molybdenum-containing coating, the method mentioned above is preferred since it is the simplest method of removing that coating.

In accordance with the invention, it is possible to selectively remove anodic oxidation coatings by using a remover composition containing phosphoric acid and a molybdate salt without substantially dissolving the basis material aluminum or aluminum alloy. Therefore, the invention is suitably applied in removing anodic oxidation coatings from aluminum or aluminum alloy parts or members to be used in semiconductor device manufacturing apparatus and required to have dimensional precision.

### BRIEF DESCRIPTION OF THE DRAWINGS

FIG. 1 includes photographs in lieu of drawings, showing the states of removal of an anodic oxidation coating formed in the hole of a perforated aluminum alloy plate before and after treatment with a remover composition. Thus,

FIG. 1(a) is a photograph in lieu of a drawing, showing the state (plan) of a hole of the perforated plate before removal of the anodic oxidation coating by the remover composition. FIG. 1(b) is a photograph in lieu of a drawing, showing the state (plan) of a hole of the perforated plate after treatment using the remover composition of Example 3. FIG. 1(c) is a photograph in lieu of a drawing, showing the state (plan) of a hole of the perforated plate after 30 minutes of treatment at room temperature using a 10% (by mass) aqueous solution of sodium hydroxide as a remover composition.

FIG. 2 includes two graphic representations showing the states of removal of anodic oxidation coatings each as a function of time.

### DETAILED DESCRIPTION OF THE PREFERRED EMBODIMENTS

The remover composition of the invention for removing anodic oxidation coatings from aluminum or aluminum alloy members is characterized in that it contains phosphoric acid and a molybdate salt and preferably is a remover composition containing phosphoric acid and a molybdate salt as dissolved therein. Water is preferably used as the solvent in the remover composition.

The phosphoric acid mentioned above is a component for removing (preferably removing by dissolving) anodic oxidation coatings. The phosphoric acid concentration in the remover composition is preferably 10 g/l to 400 g/l, more preferably 50 g/l to 300 g/l. When the phosphoric acid concentration is lower than 10 g/l, the rate of dissolution of anodic oxidation coatings is slow and a long period of time is required for removal treatment and, when it is in excess of 400 g/l, the rate of dissolution of anodic oxidation coatings increases but the basis metal aluminum or aluminum alloy also may possibly be dissolved; this is unfavorable. It is also possible to decrease the rate of dissolution of the aluminum or aluminum alloy by increasing the level of addition of the molybdate; however, this is not efficient since the molybdate is required in large amounts.

The molybdate is added for the purpose of inhibiting phosphoric acid from substantially dissolving the basis metal aluminum or aluminum alloy by the formation of a new molybdenum-containing coating on the aluminum or aluminum alloy surface upon exposure of the basis metal aluminum or aluminum alloy as a result of removal of the anodic oxidation coating. The molybdate concentration in the remover composition, as expressed in terms of the molybdate ion (MnO₄²⁻) concentration, is desirably 0.5 g/l to 150 g/l, more preferably 3 g/l to 50 g/l. When the molybdate ion concentration is lower than 0.5 g/l, there is a tendency for the dissolution of the basis metal aluminum or aluminum alloy to become hardly inhibited. When it is in excess of 150 g/l, the rate of dissolution of anodic oxidation coatings tends to become markedly slow, hence a long period of time is unfavorably required for removal treatment.

As the molybdate, there may be mentioned one or more molybdates selected from the group consisting of lithium molybdate, sodium molybdate, potassium molybdate, magnesium molybdate and ammonium molybdate. When one or more of these molybdates are added, they precipitate out on the aluminum or aluminum alloy surface upon exposure thereof as a result of removal of the anodic oxidation coating and form a molybdenum-containing coating and thus inhibit the dissolution of the basis metal aluminum or aluminum alloy by phosphoric acid. Attention should be paid to the fact that some molybdates, for example calcium molybdate, are scarcely soluble in water. On the other hand, molybdic acid (H₄MoO₅) is poorly soluble in the phosphoric acid solution in the above-mentioned concentration range, hence cannot be used.

Preferably, the remover composition further contains an oxidizing agent. When an aluminum or aluminum alloy member having an anodic oxidation coating formed thereon is immersed in the remover composition which does not contain any oxidizing agent, the initially colorless remover composition gradually assumes a blue color and the color becomes deeper with the passage of immersion time. This is because while a molybdenum-containing coating is formed on the basis metal aluminum or aluminum alloy simultaneously with the exposure thereof as a result of removal of the anodic oxidation coating by the action of phosphoric acid, part of the phosphoric acid dissolves the basis metal aluminum or aluminum alloy and the molybdenum-containing coating is reduced by electrons formed by this dissolution reaction and is converted to a deep blue substance called molybdenum blue, which is then removed from the basis metal aluminum or aluminum alloy. The color becomes deeper with the immersion time presumably because the process comprising formation of the molybdenum-containing coating, conversion to molybdenum blue, and removal from the basis metal aluminum or aluminum alloy is repeated until exhaustion of the molybdate ion in the remover composition. Thus, the molybdenum-containing coating is not uniformly formed on the basis metal aluminum or aluminum alloy and there arises the possibility that the basis aluminum or aluminum alloy may partly be damaged.

On the contrary, when the remover composition contains an oxidizing agent, the color of the remover composition does not change but the composition remains colorless and transparent even after immersion of an aluminum or aluminum alloy member with an anodic oxidation coating formed thereon. This is presumably because electrons formed upon reaction of part of the phosphoric acid with the basis metal aluminum or aluminum alloy are received by the oxidizing agent prior to receipt thereof by the molybdenum-containing coating and the formation of molybdenum blue is thereby inhibited. As a result, the molybdenum-containing coating will not be removed and the basis metal aluminum or aluminum alloy will not be exposed to phosphoric acid; accordingly, the basis metal aluminum or aluminum alloy surface will not be damaged but is maintained uniform.

Especially effective as the oxidizing agent to be added is a nitrate ion (NO₃⁻)-containing substance. Therefore, such a nitrate ion source substance as nitric acid, potassium nitrate, sodium nitrate, magnesium nitrate, calcium nitrate or ammonium nitrate is preferably added to the remover composition. The concentration of the above substance in the remover composition, as expressed in terms of the nitrate ion, is desirably 0.5 g/l to 200 g/l, more preferably 5 g/l to 150 g/l. At levels exceeding 200 g/l, the substance unfavorably becomes hardly soluble in the remover composition. Even when a nitrate ion concentration exceeding 200 g/l is attained, the effect of rendering the basis metal aluminum or aluminum alloy surface uniform is already at a point of saturation and, therefore, the addition in excess of 200 g/l is uneconomical. When nitric acid is used as the nitrate ion source substance, care should be exercised in selecting the level of addition thereof since when the pH of the remover composition becomes 1 or lower, the surface uniformity after treatment will be no longer obtained. The other nitrate ion source substances can be used without any particular restriction. Sodium persulfate can be also be used as the oxidizing agent since it shows the same effect. Further, an aqueous hydrogen peroxide solution, which is effective in increasing the surface uniformity after treatment, can also be used although the solubility of the basis metal aluminum or aluminum alloy is increased a little.

The removal treatment is carried out by immersing an aluminum or aluminum alloy member with an anodic oxidation coating formed thereon in a remover composition containing phosphoric acid and a molybdate salt at respective predetermined concentrations, if necessary together with an oxidizing agent. The treatment temperature is preferably from 60° C. to the boiling temperature (100° C.), more preferably 70° C. to 90° C. At below 60° C., the rate of dissolution of the anodic oxidation coating is too slow, hence the treatment is not practical. The rate of dissolution of the anodic oxidation coating can be increased by raising the temperature to 70° C. or higher. On the other hand, to carry out the treatment in a boiling atmosphere is favorable for the processes of satisfactory removal of the anodic oxidation coating and successful formation of a protective coating on the basis metal aluminum or aluminum alloy; however, the concentrations of the components contained in the remover composition vary with the loss of water by evaporation and thus it is difficult to maintain the predetermined concentrations. For inhibiting boiling at the boiling temperature or higher, it is necessary to increase the pressure in the reaction field; the equipment becomes large and no more practical. Therefore, the treatment temperature is preferably below the boiling temperature, more preferably not higher than 90° C.

While the removal treatment time varies depending on the thickness of the anodic oxidation coating formed on the aluminum or aluminum alloy member, the method of formation thereof, the execution or no execution of sealing and the concentrations of the respective components in the remover composition, among others, the treatment time is preferably not longer than 120 minutes. When the treatment time is longer than 120 minutes, the work efficiency is uneconomically poor. The removal treatment time is as follows. Thus, for example, when a remover composition containing 110 g/l of phosphoric acid, 10 g/l of sodium molybdate and 20 g/l of nitric acid is heated to 80° C. and various 6061 aluminum alloy members with an anodic oxidation coating formed thereon are immersed in the remover composition, the rate of removal of the anodic oxidation coating is about 1 μm/min to 5 μm/min. Therefore, in the case of a 6061 aluminum alloy member with a 25-μm-thick anodic oxidation coating formed thereon, the removal treatment time is desirably 5 minutes to 25 minutes or longer. When no oxidizing agent is added to the remover composition, the molybdate ion is totally consumed with the immersion time, the molybdenum-containing coating is no longer uniformly formed on the basis metal aluminum or aluminum alloy surface and part of the phosphoric acid may damage the basis metal aluminum or aluminum alloy, as already mentioned hereinabove, and therefore care should be exercised in selecting the treatment time.

When an anodic oxidation coating is removed using the above-mentioned remover composition, a molybdenum-containing coating is formed on the aluminum or aluminum alloy member surface. Therefore, it is necessary to remove the molybdenum-containing coating in an after-treatment step. The molybdenum-containing coating can be removed with ease by immersion in an aqueous nitric acid solution containing 50 g/l to 360 g/l of the nitrate ion. The aqueous nitric acid solution dissolves and removes the molybdenum-containing coating but does not substantially dissolve the aluminum or aluminum alloy and, therefore, the molybdenum-containing coating can be dissolved and removed selectively. Further, immersion in an aqueous sodium hydroxide solution prior to immersion in the aqueous nitric acid solution, or immersing twice in the aqueous nitric acid solution, or other various treatments before and/or after nitric acid treatment are also preferred modes of embodiment.

The anodic oxidation-treated aluminum or aluminum alloy member to which the present invention is applicable is not particularly restricted but includes members used as parts or members constituting semiconductor manufacturing apparatus used for semiconductor device manufacture, such as dry etching, CVD, and sputtering apparatus. As specific examples, there may be mentioned perforated plates (e.g. shower plates), chambers, exhaust dispersing plates, electrode plates, electrostatic chuck substrates and so forth. The invention is applicable to members required to have a high level of dimensional precision, such as perforated plates, in particular.

The aluminum alloy mentioned above is not particularly restricted but includes, for example, aluminum alloys defined in JIS H 4000, such as 1080, 1070, 1050, 1100, 1200, 1N00, 2014, 2017, 2024, 3003, 3203, 3004, 3005, 5005, 5052, 5652, 5154, 5254, 5454, 5082, 5182, 5083, 5086, 5N01, 6061, 6063, 7N01 and 7075.

### EXAMPLES

### Experiment Example 1

6061 aluminum alloy sheets shaped to 30 mm in width×40 mm in length×3 mm in thickness, and 6061 aluminum alloy sheets, 30 mm in width×40 mm in length×3 mm in thickness, with an about 25-μm-thick anodic oxidation coating formed thereon using a sulfuric acid-based treatment solution, followed by sealing treatment were each subjected to mass measurement and one piece thereof was immersed in each remover composition specified in Table 1 and adjusted to the predetermined temperature specified in Table 1 and, after 30 minutes of immersion, was taken out. Then, each test piece taken out was washed with water and then immersed in an aqueous nitric acid solution (200 g/l) for 2 minutes, then washed with water and dried and the mass thereof was measured. For each test piece, the decrease in thickness of the basis metal aluminum alloy as resulting from etching of the test piece was calculated from the loss in mass as compared with the mass before immersion. The 6061 aluminum alloy test pieces with the anodic oxidation coating were each observed by the eye as to whether the anodic oxidation coating could be removed or not. The results are shown in Table 1.

The decrease in thickness of the aluminum alloy was calculated considering that the density of the 6061 aluminum alloy was 2.7 g/cm³ and that all the faces were etched uniformly. For the 6061 aluminum alloy pieces with the anodic oxidation coating, it was preliminarily confirmed, by using a phosphoric acid-chromic acid mixed solution capable of dissolving the anodic oxidation coating alone, that the mass of the anodic oxidation coating formed on each anodic oxidation-treated 6061 aluminum alloy piece used in this experiment was 0.12 g. Therefore, the difference obtained by subtracting this anodic oxidation coating mass (0.12 g) from the decrease in mass of each 6061 aluminum alloy piece having the anodic oxidation coating was regarded as the mass of the basis metal aluminum alloy dissolved in excess, and the decrease in thickness was calculated accordingly.

| | Components contained in remover composition | | | | | | |
|---|---|---|---|---|---|---|---|
| | | | | | Oxidizing agent | | |
| | | Molybdate salt | | | | Source | |
| | | | Source substance | | | substance | |
| | Phosphoric | Molybdate | Sodium | Potassium | Nitrate | Potassium | Sodium |
| | acid | ion | molybdate | molybdate | ion | nitrate | hydroxide |
| | [g/l] | [g/l] | [g/l] | [g/l] | [g/l] | [g/l] | [g/l] |
| Example 1 | 110 | 7.8 | 10 | — | — | — | — |
| Example 2 | 110 | 38.8 | 50 | — | — | — | — |
| Example 3 | 110 | 7.8 | 10 | — | 12.3 | 20 | — |
| Example 4 | 110 | 7.8 | 10 | — | 61.3 | 100 | — |
| Example 5 | 150 | 15.5 | 20 | — | — | — | — |
| Example 6 | 330 | 77.7 | 100 | — | — | — | — |
| Example 7 | 50 | 10.1 | 13 | — | — | — | — |
| Example 8 | 50 | 8.7 | — | 13 | — | — | — |
| Comp. Ex. 1 | 110 | — | — | — | — | — | — |
| Comp. Ex. 2 | — | 7.8 | 10 | — | — | — | — |
| Comp. Ex. 3 | — | — | — | — | — | — | 100 |

| | | | 6061 aluminum alloy with anodic | |
|---|---|---|---|---|
| | | 6061 aluminum | oxidation coating | |
| | | alloy | | Decrease in thickness |
| | Treatment | Decrease in | Removal of | of basis |
| | temperature | thickness | anodic oxidation | metal aluminum |
| | [° C.] | [μm] | coating | [μm] |
| Example 1 | 80 | 0.0 | ◯ | 0.0 |
| Example 2 | 80 | 1.2 | ◯ | 0.5 |
| Example 3 | 80 | 0.0 | ◯ | 0.0 |
| Example 4 | 80 | 0.0 | ◯ | 0.2 |
| Example 5 | 80 | 0.1 | ◯ | 1.4 |
| Example 6 | 80 | 8.9 | ◯ | 1.7 |
| Example 7 | 100 | 0.0 | ◯ | 0.0 |
| Example 8 | 100 | 0.8 | ◯ | 1.2 |
| Comp. Ex. 1 | 80 | 26.0 | ◯ | 13.9 |
| Comp. Ex. 2 | 80 | 0.0 | X | 0.0 |
| Comp. Ex. 3 | 25 | 39.4 | ◯ | 34.4 |

◯: Anodic oxidation coating could be removed.
X: Anodic oxidation coating could not be removed.

As shown in Table 1, the aqueous phosphoric acid solution (Comparative Example 1) and aqueous sodium hydroxide solution (Comparative Example 3) could remove the anodic oxidation coating; however, the decrease in thickness due to etching of the 6061 aluminum alloy was in excess of 10 μm. The aqueous sodium molybdate solution (Comparative Example 2) could not remove the anodic oxidation coating. On the contrary, for each of the remover compositions containing phosphoric acid and a molybdate salt according to the invention (Examples 1-8), the decrease in thickness due to etching of the 6061 aluminum alloy was not in excess of 10 μm and, for each of the 6061 aluminum alloy pieces having the anodic oxidation coating, the anodic oxidation coating could be removed successfully and the decrease in thickness due to etching of the basis metal aluminum alloy was not in excess of 10 μm and, thus, the basis metal aluminum alloy was not substantially dissolved.

### Experiment Example 2

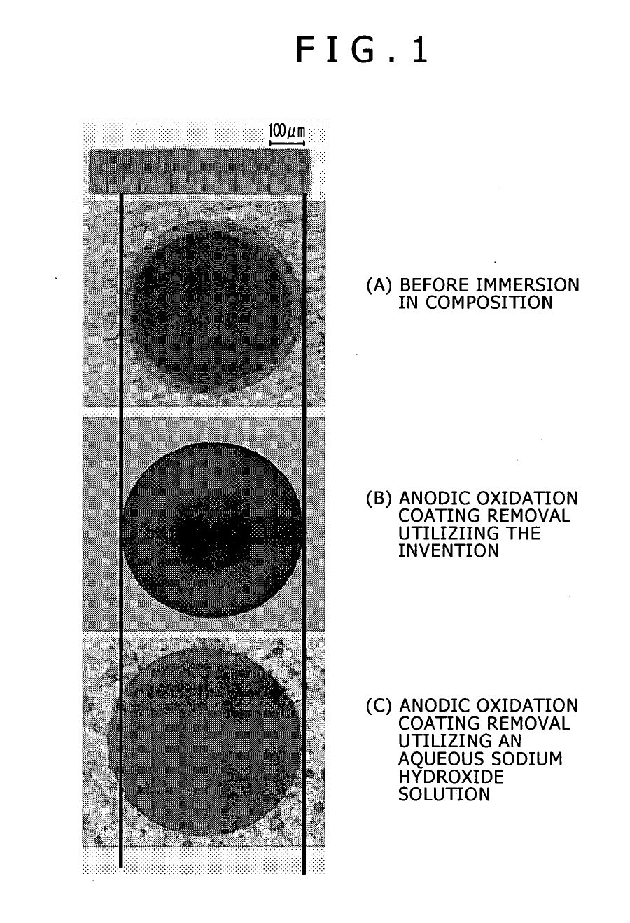

A perforated plate made from a 6061 aluminum alloy plate, 30 mm in width×30 mm in length×5 mm in thickness, having a number of holes with a diameter of 0.5 mm and having an anodic oxidation coating on all faces including the hole inside walls was immersed in the remover composition of Example 3 (as specified in Table 1) heated to 80° C. for 30 minutes for removing the anodic oxidation coating. Then, the plate was washed with water and immersed in an aqueous nitric acid solution (200 g/l) for 2 minutes, then further washed with water and dried, and the states of the holes were observed under an optical microscope. The results are shown in FIGS. 1(a)-(c). FIG. 1(a) is a photograph in lieu of a drawing, showing the state (plan) of a hole of the perforated plate before removal of the anodic oxidation coating by the remover composition. FIG. 1(b) is a photograph in lieu of a drawing, showing the state (plan) of a hole of the perforated plate after treatment using the remover composition of Example 3. FIG. 1(c) is a photograph in lieu of a drawing, showing the state (plan) of a hole of the perforated plate after 30 minutes of treatment at room temperature using a 10% (by mass) aqueous solution of sodium hydroxide as a remover composition.

As shown in FIG. 1(a), it can be confirmed that the hole of the perforated plate before treatment had an about 30-μm-thick anodic oxidation coating (portion dark in color) on the hole inside wall. Comparison between FIG. 1(a) and FIG. 1(b) reveals that when the remover composition (Example 3) according to the invention was used, the anodic oxidation coating alone was selectively removed while the diameter of the hole formed in the perforated plate remained almost unchanged. On the other hand, upon comparison between FIG. 1(a) and FIG. 1(b), it can be confirmed that the anodic oxidation coating was wholly removed with the 10% (by mass) aqueous solution of sodium hydroxide but the diameter of the hole became greater by about 30 μm. Thus, it is seen that the basis metal aluminum alloy was dissolved.

### Experiment Example 3

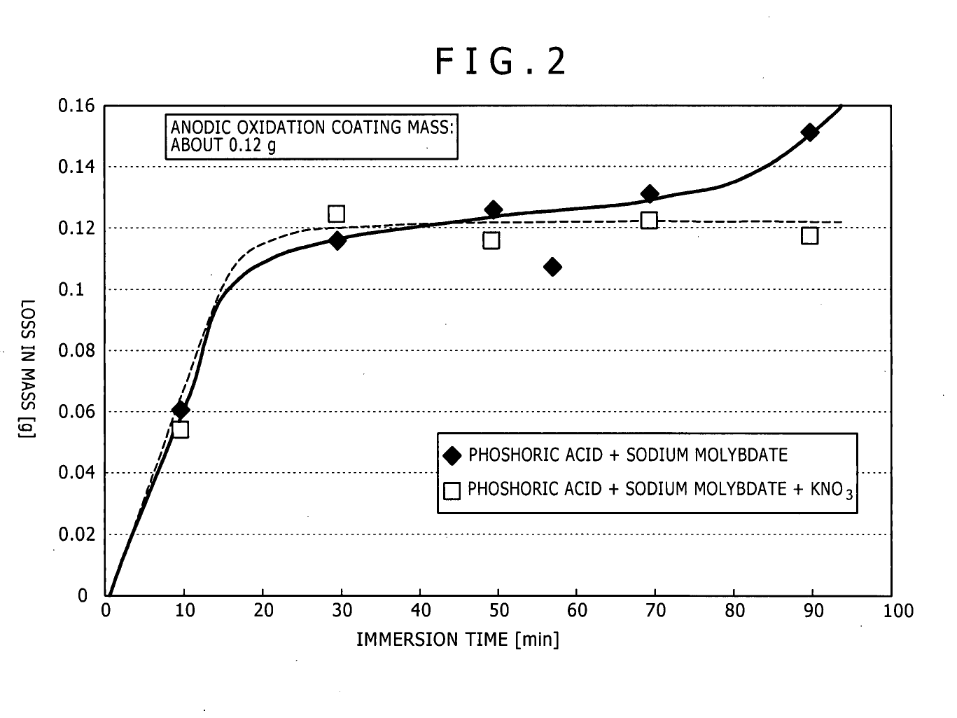

Using the remover composition of Example 1 shown in Table 1 as a remover composition containing phosphoric acid and a molybdate salt and further using the remover composition of Example 3 shown in Table 1 as a remover composition containing phosphoric acid, a molybdate salt and further the nitrate ion, 6061 aluminum alloy pieces, 30 mm in width×40 mm in length×3 mm in thickness, having an anodic oxidation coating (anodic oxidation coating weight: 0.12 g) were treated in an atmosphere of 80° C. The loses in the mass of the test pieces were measured at 10 minutes, 30 minutes, 50 minutes, 70 minutes and 90 minutes after the start of immersion. The relationships between immersion time and loss in mass are shown in FIG. 2.

As is evident from FIG. 2, it is seen that, in the case of the remover composition being free of the oxidizing agent nitrate ion, the anodic oxidation coating can be removed by 30 minutes of immersion, the changes in mass are small until 70 minutes, and the changes in mass again increases after the lapse of 90 minutes. This is presumably because when the remover composition is free of the nitrate ion, the sodium molybdate added, after formation of a molybdenum-containing coating, is converted to molybdenum blue and is removed from the aluminum alloy surface and the molybdate salt added is wholly consumed at about 70 minutes after the start of immersion and therefore cannot protect the basis metal aluminum alloy any longer, as already mentioned hereinabove.

On the other hand, when the remover composition contains the nitrate ion, it is seen that the anodic oxidation coating is removed by 30 minutes of immersion and thereafter little changes in mass occur even after 90 minutes of immersion. This is probably because the molybdenum-containing coating formed on the aluminum alloy will not be removed and the molybdate salt is not consumed totally but the coating is stably and continuously formed on the basis metal aluminum alloy surface. Thus, the optimum immersion time is restricted when the nitrate ion (oxidizing agent) is not added, whereas the immersion time can be freely varied when the nitrate ion (oxidizing agent) is added.

The present invention is suited for removing the anodic oxidation coatings formed on aluminum or aluminum alloy members by anodic oxidation.

1. An anodic oxidation coating remover composition for aluminum or aluminum alloy members which comprises phosphoric acid and a molybdate salt.

2. An anodic oxidation coating remover composition according to claim 1 which comprises phosphoric acid at a concentration of 10 g/l to 400 g/l and the molybdate salt at a molybdate ion concentration of 0.5 g/l to 150 g/l.

3. An anodic oxidation coating remover composition according to claim 1 which further comprises an oxidizing agent.

4. An anodic oxidation coating remover composition according to claim 3, wherein the oxidizing agent is the nitrate ion.

5. An anodic oxidation coating removing composition according to claim 4 which comprises the nitrate ion at a concentration of 0.5 g/l to 200 g/l.

6. A method of removing anodic oxidation coatings which comprises immersing an aluminum or aluminum alloy member having an anodic oxidation coating in a remover composition for aluminum or aluminum alloy members which comprises phosphoric acid and a molybdate salt for removal of the anodic oxidation coating and for simultaneous formation of a molybdenum-containing coating, then immersing the member in a solution capable of dissolving the molybdenum-containing coating to remove the molybdenum-containing coating.

7. A method of removing anodic oxidation coatings which comprises immersing an aluminum or aluminum alloy member having an anodic oxidation coating in a remover composition according to claim 2 for removal of the anodic oxidation coating and for simultaneous formation of a molybdenum-containing coating, then immersing the member in a solution capable of dissolving the molybdenum-containing coating to remove the molybdenum-containing coating.

8. A method of removing anodic oxidation coatings as claimed in claim 6, wherein an aqueous nitric acid solution containing the nitrate ion at a concentration of 50 g/l to 360 g/l is used as the solution for dissolving the molybdenum-containing coating.
